(19) United States
(12) Patent Application Publication
(10) Pub. No.: US 2007/0219751 A1
(43) Pub. Date: Sep. 20, 2007

(54) Sensor network data alignment with post-process resampling

(76) Inventor: Jonathan Huang, Sunnyvale, CA (US)

Correspondence Address: INTEL CORPORATION;c/o INTELLEVATE, LLC, P.O. BOX 52050, MINNEAPOLIS, MN, 55402, US

(21) Appl. No.: 11/384,112

(22) Filed: Mar. 17, 2006

(51) Int. Cl. G06F 17/40

(52) U.S. Cl. 702/187; 702/1; 702/127; 702/188; 702/189

(57) ABSTRACT

Various embodiment of the invention may look at time stamps for the start and stop times of different sensors, compare them to a standard time reference, and normalize the received data times so that corresponding data from each sensor will represent measurements taken at the same actual time.

### BACKGROUND

Each of multiple sensor nodes in a sensor network may be used to collect analog sensor readings from a sensor, convert those analog readings to digital data with an analog-to-digital converter (ADC), and report the digital data to a central computer system for interpretation. In some applications, the time references used by the various sensor devices must be accurate and synchronized to each other within a very small tolerance over a long period of time, or the collective results from multiple sensors will not be meaningful. Unfortunately, low cost crystal oscillators, from which each sensor's sampling period may be derived, may not have the desired level of accuracy, and may cause unacceptable drift over the measurement period relative to the other sensors. Conventional ways to solve this problem may use more accurate crystal oscillators, which may be too expensive for some applications, or shorter measurement times, which may cause unacceptable breaks in the data.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a diagram of a sensor network, according to an embodiment of the invention.

FIG. 2 shows a block diagram of a sensor node, according to an embodiment of the invention.

FIG. 3 shows a graphical representation of sequential data sets from multiple sensor nodes, according to an embodiment of the invention.

FIG. 4 shows a graphical representation of a reconstructed waveform, according to an embodiment of the invention.

FIG. 5 shows a flow diagram of a method, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “wireless” may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

In various embodiments of the invention, each one of multiple sensor nodes may take a series of samples by an analog-to-digital converter (ADC) for a defined period of time, and forward those samples to a central processor for integrated processing, where a sensor value taken at a particular node at a particular time may need to be processed with the sensor values from other nodes taken at the same time. Because the locally generated sampling clock used in each node may run at a slightly different frequency than the sampling clocks in the other nodes, (e.g., due to tolerances in crystal oscillator frequencies), the sequences of measurements from the various nodes may be unintentionally stretched or compressed in time. To resolve these differences and get each set of measurements on a common time base, each node may timestamp two reference samples (such as the first and last samples), using a common network time reference. Then these timestamps for different nodes may be compared, and the series of measurements from different sensor nodes may be mathematically interpolated so that equivalent parts of the measurements from different sensor nodes will correspond to identical points in time.

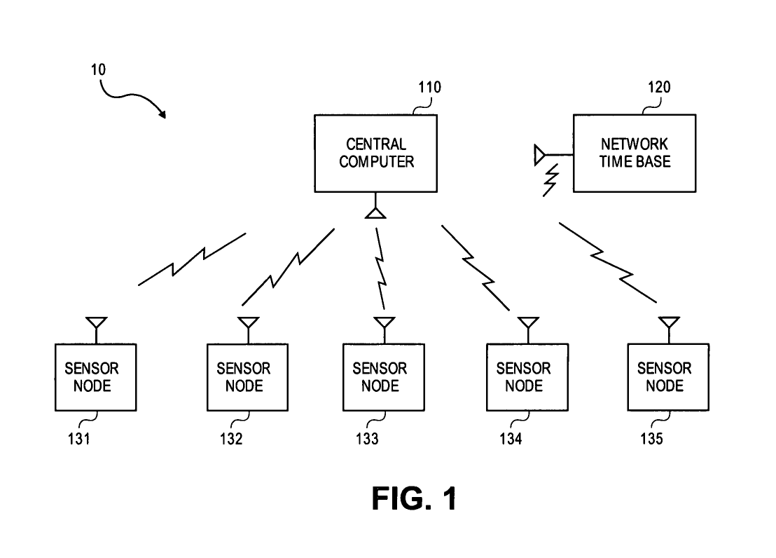

FIG. 1 shows a diagram of a sensor network, according to an embodiment of the invention. In network 10 of the illustrated embodiment, each of sensor nodes 131-135 may receive a start command from central computer 110 and begin taking samples of an analog waveform picked up by its sensor. In one embodiment the sensors may detect physical vibration (e.g.,in the form of physical displacement, such as wind-induced vibration in the support girders of a tall building or soil vibrations resulting from an earthquake), but other embodiments may measure other phenomena. The analog signal may be periodically sampled and converted to an equivalent digital value. After the analog signal has been sampled for a time, the resulting series of digital values for that measurement period may be transmitted to central computer 110, which may collect similar inputs from some or all the sensor nodes and process them together to produce an integrated result. For example, the vibrations from multiple parts of a bridge might be processed to detect oscillation or standing waves in the structure. The embodiment shown in FIG. 1 indicates one or more antennas on each of the devices, implying wireless communications between the central computer and each of the sensor nodes, but other embodiments might use hard-wired communications instead.

FIG. 1 also shows a network time base 120, which may be used to produce a time base that is identical (or at least within a defined tolerance) for all of the sensor nodes. Various techniques, both known and yet to be developed, may be used to generate this time base, distribute it to the nodes, and have each node synchronize on it if necessary, so that every node may have a uniform time reference by which to time-stamp sensor values. Although the illustration of FIG. 1 shows the network time information being distributed wirelessly to the sensor nodes (and to the central computer if needed), other embodiments may communicate the network time information through wired connections. Although the illustration of FIG. 1 shows the communication of the network time reference being separate from the communication between the central computer and the sensor nodes, other embodiments may use other techniques, such as having the network time base generated within the central computer and/or communicating the network time information from the central computer to the sensor nodes.

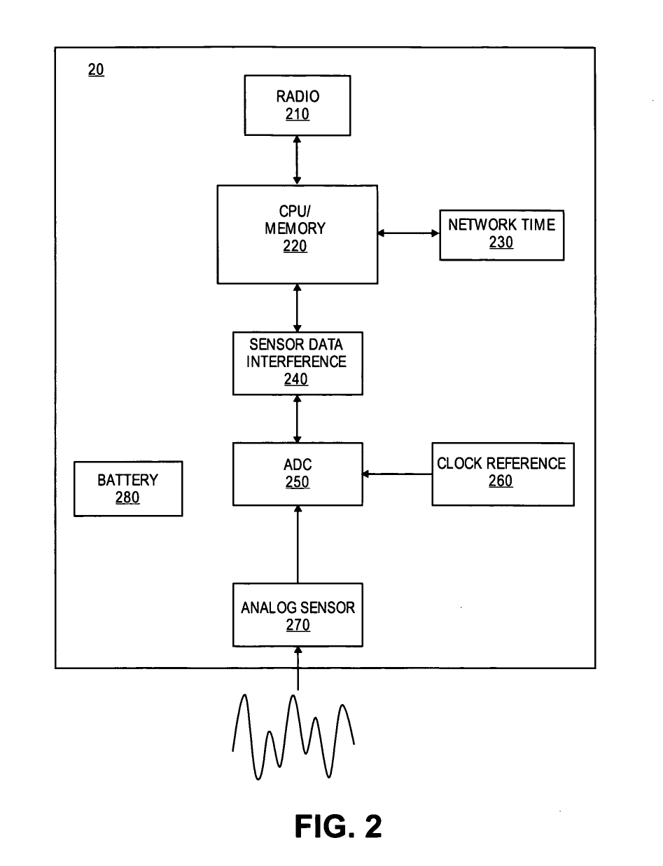

FIG. 2 shows a block diagram of a sensor node, according to an embodiment of the invention. In the illustrated embodiment, sensor node 20 comprises a radio 210 to communicate wirelessly with one or more other devices, a CPU/memory 220 to provide a processor for processing capability and memory to hold instructions and data, a sensor data interface 240 to provide sensed data to the CPU/memory 220 for processing, an analog-to-digital converter (ADC) 250 to convert analog values to digital values before presenting those digital values to the sensor data interface, and an analog sensor 270 to generate the analog inputs to the ADC 250. Sensor node 20 may also contain two clock sources: a clock reference 260 to provide timing signals to the sampling circuitry of the ADC 250, and network time logic 230 to provide a time reference that is synchronized with similar time references in other devices in the network. In some embodiments, sensor node 20 may also contain a local power source, such as battery 280, to provide operational electrical power for sensor node 20, but other embodiments may use another type of power source, such as a hard-wired connection to an alternating current (AC) electrical power source.

Analog sensor 270 may be a circuit and/or device that senses a change in a physical phenomenon and converts it to an analog electrical signal. For example, a mechanical transducer may convert pressure changes into electrical signals that vary in proportion to the pressure exerted against the transducer, an accellerometer may convert inertial changes into electrical signals that vary with accelleration, a microphone may convert acoustical waves into analog electrical signals, etc. An example of an analog waveform is shown at the bottom of FIG. 2. The analog electrical signals from analog sensor 270 may be provided to the analog input(s) of ADC 250, which may sample the analog value and convert that sample to its digital equivalent at periodic intervals. Clock reference 260 may provide a clock signal that determines the sampling rate of the ADC (i.e., how often the ADC provides a new digital output). The desired sampling rate may be based on various factors, such as but not limited to: 1) how quickly the ADC can accurately convert an analog value into a digital value, 2) how accurately the digital outputs of the ADC may be reconstructed into a replica of the original analog signal (a generally accepted rule is that the sampling rate must be at least two times the maximum frequency of the analog signal to reconstruct a reasonably accurate representation of the original analog signal), 3) the highest frequency component of the analog signal that is considered important, 4) etc. The ADC and clock frequency may be selected at design time based on these and/or other considerations. In some embodiments the sampling rate may be dynamically selected by the CPU, so that the sensor node may be adapted to the particular application.

The digital values that are periodically produced by the ADC may be transferred through a sensor data interface 240 to the CPU/memory 220. In some embodiments the interface 240 may be a simple register to temporarily hold each digital value. In other embodiments the interface 240 may contain timing and control circuitry to control the transfer. In other embodiments the interface 240 may contain a first-in first-out (FIFO) buffer for asynchronous data transfers. In still other embodiments the interface 240 may contain a memory array to temporarily store part or all of a sequence of digital values. Other embodiments may use still other techniques.

At some point, a complete sequence of digital values may have been transferred into the memory of the CPU/memory 220, which may perform various types of processing on that data. The CPU/memory 220 may also provide the sequence of digital values to radio 210, or to some other type of communications interface, which may use its transmitter to transmit the values to another device. In some embodiments the digital values may all be transmitted after sampling of the entire sequence is complete. In other embodiments some of the digital values may be transmitted while sampling is still in progress. The individual digital values in a sequence may be transmitted individually, in multiple blocks, or in a single block, depending on the embodiment. Network Time logic 230 may provide a time reference that is synchronized with a similar time reference being used by other sensor nodes in the network, so that every sensor node may have a common time reference to work with. In some embodiments, the CPU/memory may time-stamp certain digital values with the network time at which the digital value was obtained. For example, in some embodiments the initial and final digital values of a sequential data set (i.e., a set of sequential values from an ADC within a particular sensor node) may be time stamped, indicating when the set started and ended. The sequential set may be defined in various ways, such as but not limited to a fixed number of samples or a fixed amount of time.

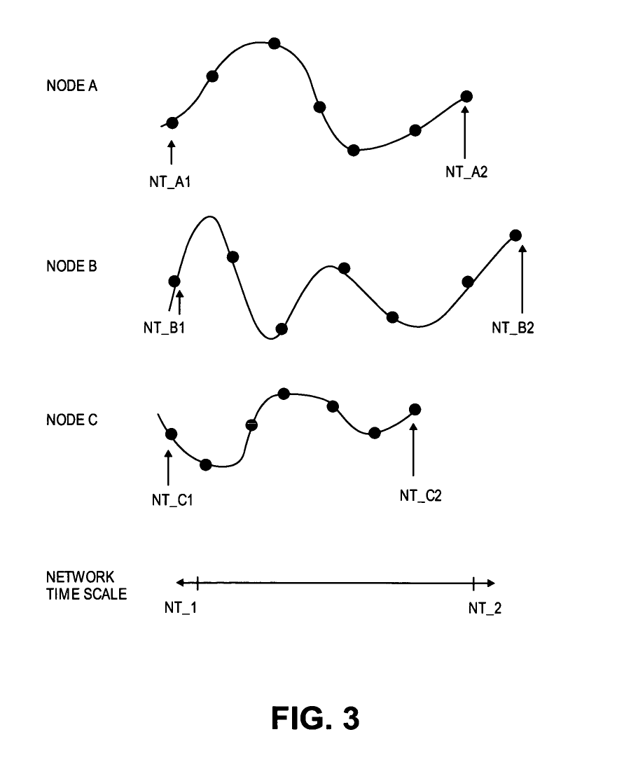

FIG. 3 shows a graphical representation of sequential data sets from multiple sensor nodes, according to an embodiment of the invention. Data for nodes A, B and C may be sequential data sets for three different sensor nodes, with each data set starting at the same time and ending after a fixed number of samples. For clarity of illustration, the examples of FIG. 3 show only seven data points in each set, but in actual operation many more data points (e.g., hundreds, thousands, millions, etc.) may be included in each data set. For each illustrated node, the curved line may represent the analog signal at the inputs of the ADC, while the dots may represent the sample points (i.e., the points at which the analog value is converted into a digital value by the ADC). The sampling rate for any particular sensor node may be controlled by a clock within that sensor node (e.g., a clock signal derived from a crystal controlled oscillator).

In many applications, it is desirable for multiple sensor nodes to obtain their samples at the same time, so that simultaneous measurements from different areas may be processed together. Accordingly, the clock references for all the sensor nodes in a network may be designed to run at the same speed so that samples from all sensor nodes will be taken at the same time throughout the sample period. However, manufacturing tolerances in the components of the clock circuits may make the different clocks run at slightly different speeds. Different operational environments (e.g., operating temperature) may cause additional variation in clock speeds. Therefore, even though the first sample in the various data sets may all be simultaneous, the different clock speeds may cause later samples to drift in time with respect to each other. If the drift is high enough, and the sampling period is long enough, the time differences at the end of the sampling period may be enough to make the data useless unless the drift can be compensated for. For clarity of illustration, FIG. 3 shows an exaggerated difference in clock speeds (approximately 15% difference between the fastest and slowest clocks), but in actual practice clock speeds may vary by only a small fraction of 1% (e.g., 0.0001%, 0.00003%, etc.).

The examples shown in FIG. 3 illustrate the effect of different clock speeds. The clock in Node B may run at a slower speed than the clock in Node A, so that Node B takes longer than Node A to obtain seven samples. The clock in Node C may run at a faster speed than the clock in Node A, so that Node C takes less time than Node A to obtain seven samples. Thus, corresponding sample points in the sequential data sets (for example, the fourth sample point of each node) may occur at different times and give erroneous results when processed together in applications which require those values to represent the same point in time. However, the various sequential data sets may be normalized for time by interpolation of the data (e.g., a virtual reconstruction and resampling of each waveform to compensate for the apparent time differences). In some embodiments, this reconstruction and resampling is described as ‘virtual’ because the results are obtained with mathematical treatment rather than by actually recreating and resampling an actual analog electrical signal.

Using a common time reference, the first sample point in each data set may be time-stamped, by attaching a value to the first sample point that represents the time the first sample point was taken. The time scale labeled Network Time Scale at the bottom of FIG. 3 is representative of such a common time reference, with NT_1 and NT_2 representing two points in that time scale. In the illustrated embodiment, NT_A1 may be the time stamp associated with the first sample point of Node A, NT_B1 may be the time stamp associated with the first sample point of Node B, and NT_C1 may be the time stamp associated with the first sample point of Node C. In the illustration, the first sample point of all three nodes occurs at the same time, and therefore time stamps NT_A1, NT_B1, and NT_C1 may all be identical in value, but in other embodiments the first sample points may not occur at the same time and may not have identical timestamp values.

In the illustrated example, the seventh (and final) data point in every sequential data set (NT_A2, NT_B2, NT_C2) may also be time stamped with the time it was taken. However, due to the aforementioned relative drift, the last sample points may not occur at the same time for every sensor node even if the first sample points did occur at the same time, and therefore may not have the same time value. However, with proper interpolation, each analog signal may be virtually reconstructed and the value of the virtually reconstructed analog signal at a given point in time may be determined. By performing this interpolation on the sequential data sets for every node, it is possible to obtain a set of resample points for each analog signal such that corresponding resample points for different nodes represent the value of the respective sensor signals at the same point in time. Thus, the resampled data sets may be equivalent to what would have been obtained if the sampling clocks in all sensor nodes were all synchronized with each other.

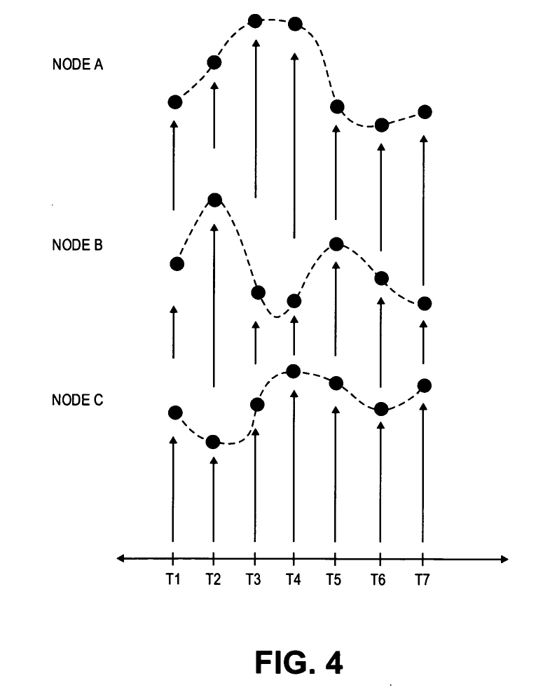

FIG. 4 shows a graph of a reconstructed waveform, according to an embodiment of the invention. The reconstructed waveforms are shown with dotted lines. New sample points may be determined for these reconstructed waveforms, with corresponding sample points representing the same point in time (e.g., times T1-T7) for every sensor node. The digital values for the corresponding new sample points may therefore represent sensor values for identical points in time for every sensor node. In the example shown, the original seven sample points for Node C have been adopted as new sample points, but other embodiments may choose new sample points without regard to the original sample points for any node, and the quantity of new sample points may or may not be the same as the quantity of original sample points for any particular node. Although the reconstructed waveform is shown in FIG. 3 as an actual analog waveform, in some embodiments the reconstructed waveform and/or sample points may not have physical form, but only be concepts represented by the mathematical treatment which produces the desired results.

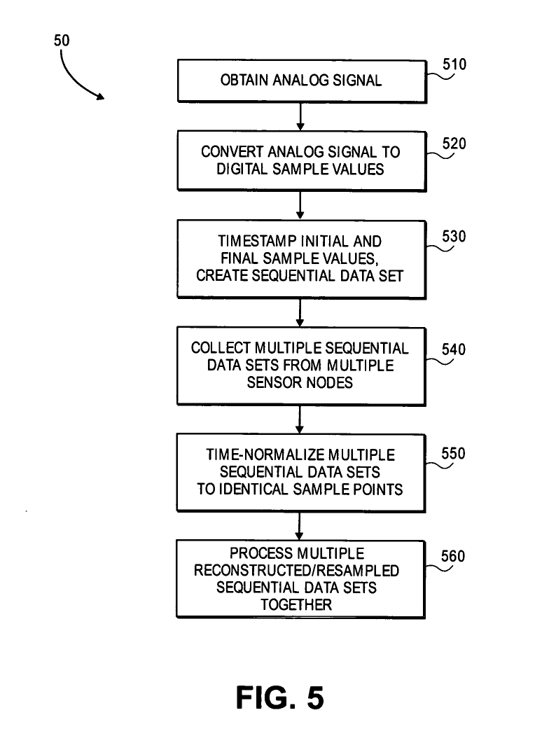

FIG. 5 shows a flow diagram of a method, according to an embodiment of the invention. In some embodiments, the operations at 510, 520, and 530 may be performed in each of multiple sensor nodes, while the operations at 540, 550, and 560 may be performed in a single device, such as a central computer system. In some embodiments the single device may be a separate device from all of the sensor nodes, but in other embodiments the single device may be one of the sensor nodes. In flow diagram 50, an analog signal may be obtained at 5 10. In some embodiments, the signal may be obtained when an analog sensor converts a physical phenomenon with analog characteristics into an electrical analog signal. At 520 this analog signal may be converted into digital sample values, i.e., into a sequential set of digital data values. The sequential data values may be generated by using an ADC to sample the value of the analog signal at defined intervals and convert each sampled analog value into a digital value. The sampling period may be defined in various ways, such as but not limited to: 1) a fixed number of samples, or 2) the samples obtained in a fixed amount of time. At 530 two data samples (e.g., the initial and final data samples) in the set may be timestamped, i.e., a numerical value indicating the time a sample was obtained may be associated with the respective sample value. These timestamps, along with the digital values obtained during the sampling period, may be organized into a sequential data set.

Multiple sensor nodes may each complete the operations of 510, 520, and 530 at approximately the same time. When multiple sensor nodes have done so, a computer system may collect the sequential data sets from the multiple sensor nodes at 540. By comparing the timestamps within each data set, the computer system may then normalize the various data sets with respect to time at 550, so that interpolated resample values from the various data sets will represent the value of the analog signal from the various sensor nodes at the same points in time. This process may be performed for every data set to obtain a sequential set of reconstructed sample values for each sensor node, in which each resample point in a data set represents the analog value of the original analog signal, and corresponding resample points for multiple sensor nodes represent the respective values from the sensor nodes at the same points in time. Various mathematical treatments may be used in this normalization procedure. For example, in some embodiments a Lagrange interpolation may be used. In some embodiments a Farrow structure may be used to implement the Lagrange interpolation. In some embodiments a quadratic interpolator may be used. Other embodiments may use other mathematical techniques, either currently known and yet-to-be-discovered.

Once time-synchronized data sets have been obtained for multiple sensor nodes, the data sets may be further processed at 560 to produce analytical data for various purposes. For example, when vibration is monitored at various points, the combined analog inputs may be processed in the described manner to produce meaningful analysis. Such systems may include, but are not limited to, such things as: 1) measuring vibration in the structure of a building or bridge to predict structural fatigue, 2) measuring vibration in the earth's crust to locate and analyze earthquakes or volcanic eruptions, 3) measuring sound at multiple microphones to determine direction and/or location of a sound source, 4) etc.

The foregoing description is intended to be illustrative and not limiting. Variations will occur to those of skill in the art. Those variations are intended to be included in the various embodiments of the invention, which are limited only by the spirit and scope of the following claims.

1. An apparatus, comprising:
a sensor;
an analog-to-digital converter (ADC) coupled to the sensor;
a clock circuit coupled to the ADC to control a sampling rate of the ADC;
a processor with memory coupled to the ADC to receive a sequence of digital values from the ADC;
a time reference coupled to the processor, wherein the processor is to timestamp at least two values in the sequence with time values provided by the time reference, each of the timestamps to indicate a time at which the associated digital value was obtained; and
a communications interface coupled to the processor to transfer the sequence and the timestamps to another device.

2. The apparatus of claim 1, wherein the time reference is a network time reference configured to provide a common time base to multiple apparatuses in a network.

3. The apparatus of claim 1, wherein the communications interface comprises a radio transmitter.

4. The apparatus of claim 3, further comprising a battery to provide electrical power to the processor.

5. The apparatus of claim 1, wherein the sensor comprises a vibration sensor.

6. An apparatus, comprising
a computer with a communications interface, the computer to:
receive a first sequence of sensor values from a first sensor device and receive a second sequence of sensor values from a second sensor device, wherein each of at least two values in the first sequence and at least two values in the second sequence have been timestamped with a time at which the value was obtained, using a time reference common to the first and second sensor devices; and
normalize the two sequences to a common time period so that derived values for selected points in the first sequence correspond in sampling time to derived values for selected points in the second sequence.

7. The apparatus of claim 6, wherein the computer is to normalize the two sequences using a mathematical treatment.

8. The apparatus of claim 7, wherein the mathematical treatment comprises at least one treatment selected from a list consisting of interpolation, Lagrange interpolation, and a Farrow structure.

9. The apparatus of claim 6, further comprising an antenna coupled to the computer.

10. A method, comprising:
sensing an analog signal from a sensor;
converting the analog signal to a sequence of digital values;
timestamping one of the digital values with a first time at which said one of the digital values was obtained;
timestamping another of the digital values with a second time at which said another of the digital values was obtained; and
transmitting the sequence of digital values and the timestamp values to another device.

11. The method of claim 10, wherein said timestamping is based on a time source that provides a time reference common to multiple sensor nodes.

12. The method of claim 10, wherein said converting comprises sampling the analog signal at intervals controlled by a clock signal originating from a local oscillator.

13. The method of claim 10, wherein said one of the digital values is an initial value in the digital values, and said another of the digital values is a final value in the digital values.

14. A method, comprising:
receive a first set of digital values from a first sensor node, the first set of values representing sequential digitized samples of a first analog signal;
receive a first time value indicating a time at which an initial value in the first set was obtained and receive a second time value indicating a time at which a final value in the first set was obtained;
receive a second set of digital values from a second sensor node, the second set of values representing sequential digitized samples of a second analog signal;
receive a third time value indicating a time at which an initial value in the second set was obtained and receive a fourth time value indicating a time at which a final value in the second set was obtained, wherein the first, second, third, and fourth time values are based on a common time reference;
normalize the first and second sets to a same time base, based on the first, second, third, and fourth time values; and
analyze the normalized first and second sets to produce a vibration analysis of a physical structure.

15. The method of claim 14, wherein said normalizing comprises interpolating the first and second sets, such that resample points for the interpolated first set correspond in time to resample points for the interpolated second set.

16. The method of claim 15, wherein said interpolating comprises using a Lagrange interpolation.

17. An article comprising
a tangible machine-readable medium that contains instructions, which when executed by one or more processors result in performing operations comprising:
receiving a series of digital values from an analog-to-digital converter, the digital values representing sample points of an analog signal from a sensor;
timestamping one of the digital values with a first time value at which one of the digital values was obtained;
timestamping another of the digital values with a second time value at which said another of the digital values was obtained; and
transmitting the series of digital values, the first time value, and the second time value to another device.

18. The article of claim 17, wherein the operations of timestamping comprise timestamping based on a time source that provides a common time reference to multiple devices.

19. The article of claim 17, wherein said one of the digital values is an initial one of the digital values in the series, and said another of the digital values is a final one of the digital values in the series.

20. An article comprising
a tangible machine-readable medium that contains instructions, which when executed by one or more processors result in performing operations comprising:
receive a first set of digital values from a first sensor node, the first set of values representing digitized sequential samples of a first analog signal;
receive a first time value indicating a time at which an initial value in the first set was obtained and receive a second time value indicating a time at which a final value in the first set was obtained;
receive a second set of digital values from a second sensor node, the second set of values representing digitized sequential samples of a second analog signal;
receive a third time value indicating a time at which an initial value in the second set was obtained and receive a fourth time value indicating a time at which a final value in the second set was obtained, wherein the first, second, third, and fourth time values are based on a common time reference; and
normalize the first and second sets to a common time base, based on the first, second, third, and fourth time values.

21. The article of claim 20, wherein
the operation of normalizing comprises mathematically interpolating the first and second sets, such that resample points for the first set correspond in time, based on the common time reference, to resample points for the second set.

22. The article of claim 20, wherein said mathematically interpolating comprises using quadratic interpolation.
